(19) United States
(12) Patent Application Publication
(10) Pub. No.: US 2005/0136192 A1
(43) Pub. Date: Jun. 23, 2005

(54) Surface treatment method

(75) Inventor: Fu-Kung Huang, Hualien County (TW)

Correspondence Address: BIRCH STEWART KOLASCH & BIRCH, PO BOX 747, FALLS CHURCH, VA, 22040-0747, US

(73) Assignee: ASUSTek COMPUTER INC.

(21) Appl. No.: 11/017,743

(22) Filed: Dec. 22, 2004

(30) Foreign Application Priority Data
Dec. 23, 2003 (TW) 92136638

(51) Int. Cl. B05D 1/18

(52) U.S. Cl. 427/430.1

(57) ABSTRACT

A method of surface treatment used to process the surface of an object with uneven surface, including: firstly, immersing a film, of which the surface is covered by paint, into a liquid. The paint is then floated on the liquid. Secondly, immerse an object into the liquid to allow paint transfer.

This application claims the benefit of Taiwan application Serial No. 92136638, filed Dec. 23, 2003, the subject matter of which is incorporated herein by reference.

### BACKGROUND OF THE INVENTION

1. Field of the Invention

The invention relates in general to a surface treatment method, and more particularly to a water transfer printing that forms a paint layer on objects with uneven surface.

2. Description of the Related Art

The standard of scientific craft advances rapidly nowadays. In order to improve the look and feel of products, certain degree of surface treatment is carried out in order to increase the competitiveness of the products.

Therefore, allowing the products have the visual effect of different material, and color, and improve the look and feel of the products' surfaces is a major task of researchers.

### SUMMARY OF THE INVENTION

It is therefore an object of the invention to provide method of surface treatment to allow the surfaces of products, so that the add-on values of the products can be greatly increased.

The invention achieves the above-identified object by providing a method of surface treatment used to process the surface of an object with uneven surface. The surface treatment method includes the following: firstly, a step is carried out to wet paint by immersing a film, of which the surface is covered by paint, into a liquid and then floats the film on the liquid. Secondly, a transfer print step is carried out by immerse an object in the liquid so that the paint is transfer printed on the uneven surface of the object.

In the method of surface treatment, the method to create uneven surface for an object could include the following: firstly, a pattern carving process is carried out by carve patterns on at least a mold of the object so that the surface of the mold has the carved pattern. Then, a plastic is filled into the mold in order to obtain the object, of which the surface has the said pattern.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flow chart of the surface treatment method of an preferred embodiment according to the invention.

FIG. 2 depicts a diagram to transfer print the printing ink to the surface of an uneven object according to the embodiment of the invention.

FIG. 3 shows a diagram illustrating the process to transfer print the ink 211 and to paint the protection layer 301 on the uneven surface 203 of the object 201.

FIG. 4 is a flow chart showing the method to create uneven surface on objects according to the surface treatment method of the invention.

### DETAILED DESCRIPTION OF THE INVENTION

A preferred embodiment is used to provide detail explanation of the invention. However, the embodiment, one of the surface treatment methods under the spirit of the invention, does not limit the scope of the invention. Thereinafter, the features of the invention are explained in the followings.

There are many methods to create color pictures on the surface of products to make them having exquisite color patterns. The traditional printing or painting method does not work well on complicated products such as car's dashboard, steering wheel, computer housing, mobile phone, mouse, glasses, or rackets.

However, this problem can be easily solved using water transfer printing. Water transfer printing can transfer print color pictures, and is also suitable for application on products with different material. Furthermore, the lively color of the picture of water transfer print can greatly increase the add-on value of the product.

The property of water transfer print makes it suitable for products of complicated mold. Water transfer print can be applied in a great variety of materials like plastics, metal, glass, and porcelain.

The number of general basic pattern of water transfer print is in the range of several hundreds. Natural looking patterns such as peach wood, mica and emerald are so similar to the real material. Therefore, water transfer print, in some sense, reduces the consuming of nature resources.

Usually, water transfer print is used on even and smooth surfaces. However, this invention applies the technique of the water transfer print on products with uneven surfaces to form to lively pictures.

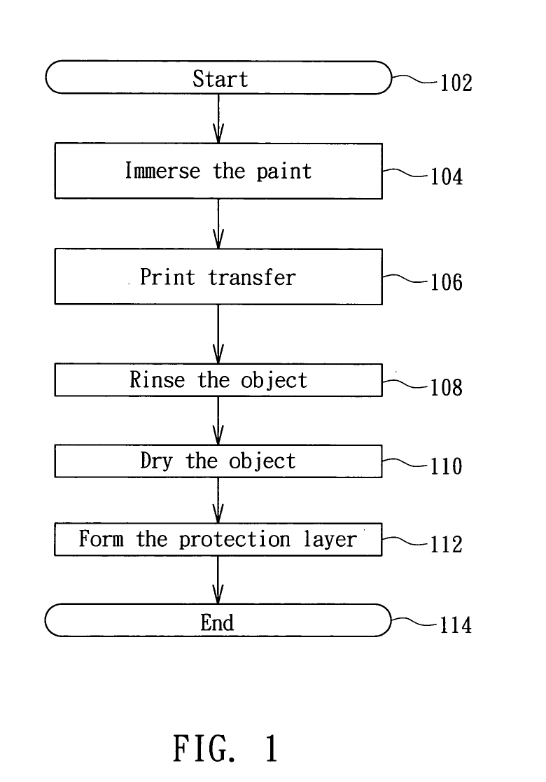

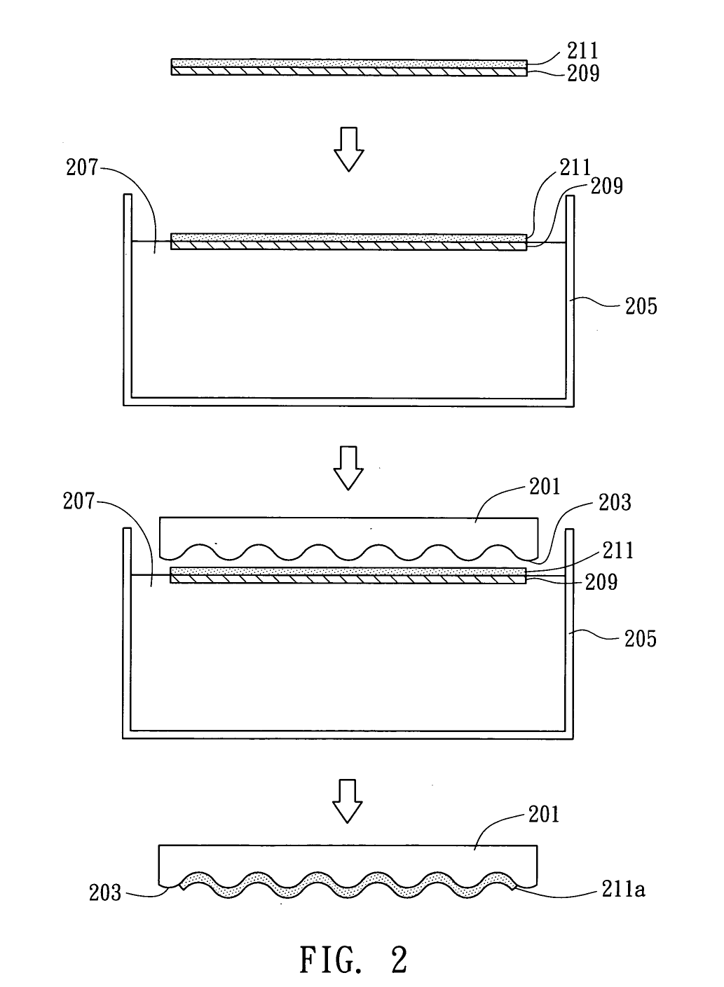

Referring to FIG. 1 and FIG. 2, FIG. 1 is a flow chart of the surface treatment method according to the preferred embodiment of the invention and FIG. 2 depicts a diagram that the surface treatment method transfer print onto objects with uneven surface using printing ink. The surface treatment method of the invention can be applied to objects with uneven surface pattern. FIG. 2 enlarges the uneven surface pattern of the object 203 in order to show it clearly. Firstly, in step 102, the surface treatment method of the invention is started. Then, in step 104, a step to wet the paint is carried out. A part of the film 209, of which the surface is covered by paint, such as ink 211, is immersed into liquid such as water 207 in the container 205. The step 104 allows the film 209 to float on the water 207.

Preferrably, before the film 209 is immersed into the water, an activator is used to activate the ink 211 on the film 209. The effect of the activator is to separate the ink 211 from the film 209 while the film 209 is immersed in the water.

Subsequently, in step 106, a process of transfer print is carried out. The object 201 to be printed, which has uneven surface pattern, is immersed into the water 207 in the container 205. With the aid of the liquid pressure, the ink 211 is evenly transferred onto the surface of the object 203, which forms a paint layer 211a. Therefore, the surface of the object 203 has the desired patterns.

Then, in step 108, a cleansing process is carried out. The object 201 is rinsed by water to remove ink residue on the surface of the object.

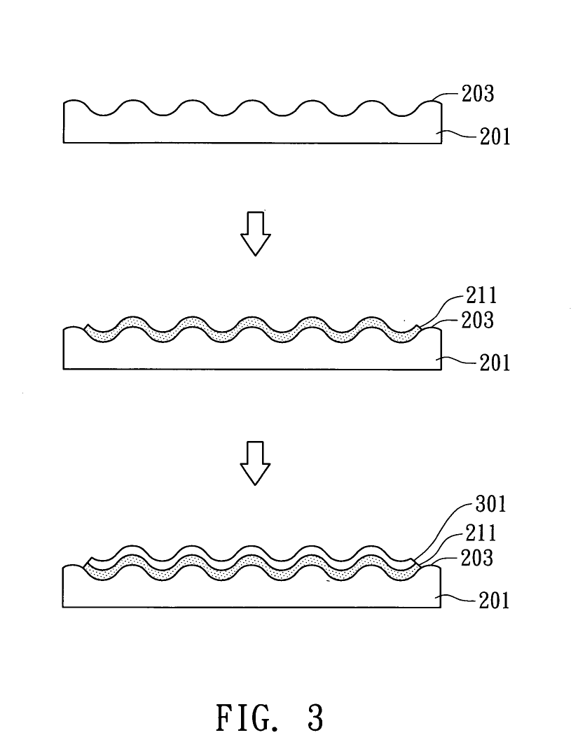

In step 110, a drying processing is carried out. Then, in step 112, a protection layer 301 is formed on the paint layer 211a to prevent the ink 211 separating from the object 203. FIG. 3 depicts a diagram showing the processes of paint transferring and the formation of the protection layer 301 on the uneven surface 203 of the object 201 in order. The material of the protection layer is preferably transparent such as PU glue or UV glue. Finally, in step 114, the surface treatment method the invention is completed.

The step 104, paint immersing and the step 106, paint transferring can be implemented by using an automated method and a manual method.

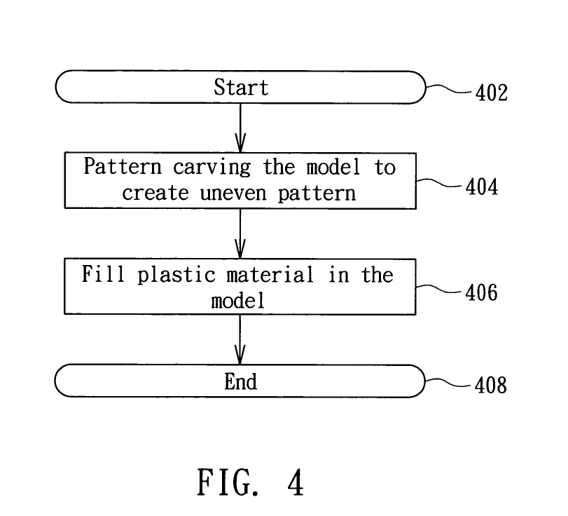

Please refer to FIG. 4, which is a flow chart showing one method of creating an object with uneven surface. Firstly, step 402 is the start point of forming the object. Then, in step 404, a pattern carving process is performed on the surface of a mold. Subsequently, in step 406, a plastic material is filled to the mold in order to obtain an object with the pattern. Finally, in step 408, the object with uneven surface is formed. The above method is in generally called pattern carving.

To create uneven surface pattern, an alternative method can be used, that is sand blasting. Pattern carving is often used to form uneven surface in plastic materials. Sand blasting is more often applied in metallic material, in addition to plastic materials.

No matter whether the pattern carving method or the sand blasting is used, the product can be more anesthetic, less displeasing, and more durable on the surface. Moreover, it can protect the surface from been scratched, prevent dust, avoid the surface getting dirty, and reduce the displeasing feeling of the user due to light reflection.

It can be known that the water transfer printing technique gives the product different textural such as wood, stone, cloth, leather, and different visual effect. And pattern carving and sand blasting provide the surface of products nice textural feeling. Therefore, the product manufactured according to the surface treatment method of the invention has both the visual effect of the water transfer print, and the nice textural feeling from the pattern carving.

Therefore, products manufactured according to the surface treatment method of the invention can include the advantages of both the water transfer printing technique and the molding (or sand blasting) method to create uneven surface pattern, and therefore, the add-on value of the product is greatly increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A surface treatment method for treating an object with an uneven surface, comprising:
a step of paint immersing, by immersing at least a part of a film coated with a paint in a liquid to allow the film to float on the liquid; and
a step of paint transferring, by immersing the object in the liquid to allow the paint to be transferred onto the uneven surface of the object.

2. The surface treatment method according to claim 1, wherein the uneven surface is formed by a molding method, comprising:
carving a pattern on at least a surface of a mold; and
filling a plastic into the mold to form the object with the pattern.

3. The surface treatment method according to claim 1, wherein a material of the object is a plastic.

4. The surface treatment method according to claim 1, wherein a material of the object is a metal.

5. The surface treatment method according to claim 4, wherein the uneven surface pattern is formed by a sand blasting method.

6. The surface treatment method according to claim 1, after the step of paint transferring, further comprising a cleansing step for cleaning the object.

7. The surface treatment method according to claim 6, wherein water is used in the cleaning step to remove residues.

8. The surface treatment method according to claim 6, after the step of cleaning, further comprising a step of drying.

9. The surface treatment method according to claim 8, after the step of drying, further comprising a step of forming a protection layer on the surface of the object covered the paint.

10. The surface treatment method according to claim 9, wherein the protection layer is a transparent coating.

11. The surface treatment method according to claim 10, wherein the transparent coating is PU glue.

12. The surface treatment method according to claim 10, wherein the transparent coating is UV glue.

13. The surface treatment method according to claim 1, wherein the paint is ink.

14. The surface treatment method according to claim 1, wherein, in the step of paint immersing, an activator is used to activate and separate the paint from the film.

15. The surface treatment method according to claim 1, wherein the liquid is water.

16. The surface treatment method according to claim 1, wherein the step of paint immersing and the step of paint transferring are implemented by using an automated method.

17. The surface treatment method according to claim 1, wherein the step of paint immersing and the step of paint transferring are implemented by using a manual method.
